(19) United States
(12) Patent Application Publication
(10) Pub. No.: US 2023/0367020 A1
(43) Pub. Date: Nov. 16, 2023

(54) Method for Classifying Objects in an Environment of a Vehicle as Objects That Can Be Driven Under or as Objects on the Roadway, Computing Device and Driver Assistance System

(71) Applicant: Bayerische Motoren Werke Aktiengesellschaft, Muenchen (DE)

(72) Inventor: Georg TANZMEISTER, Muenchen (DE)

(21) Appl. No.: 18/029,134

(22) PCT Filed: Aug. 30, 2021
(86) PCT No.: PCT/EP2021/073854

§ 371 Date: Mar. 29, 2023

(30) Foreign Application Priority Data
Oct. 5, 2020 (DE) 10 2020 125 977.8

(51) Int. Cl. G01S 17/931; G01S 13/931; G08G 1/16; G06V 10/764

(52) U.S. Cl. CPC G01S 17/931; G01S 13/931; G06V 10/764; G08G 1/16; G06V 2201/07

(57) ABSTRACT

A method for classifying objects includes receiving sensor data from an environment sensor of the vehicle; recognizing, based on the sensor data, an object in a region of a roadway; determining an object region on the roadway with which the object is associated; assigning a base point to the object based on the sensor data; determining the height of the base point with respect to a vehicle vertical direction; determining the roadway height with respect to the vehicle vertical direction in the object region under the assumption of a predetermined grade of the roadway between a forward-zone region of the roadway in front of the vehicle and the object region; and classifying the object as an object that can be driven under, if the difference between the roadway height and the height of the base point exceeds a predefined threshold value.

### BACKGROUND AND SUMMARY OF THE INVENTION

The present invention relates to a method for classifying objects in an environment of a vehicle. In addition, the invention relates to a computing device for a driver assistance system and to a driver assistance system for a vehicle. Finally, the present invention relates to a computer program.

Modern vehicles comprise driver assistance systems which can be used to facilitate automated driving of the vehicle. Such driver assistance systems comprise a plurality of environmental sensors by way of which objects in the environment of the vehicle can be detected. One problem in the perception for automated driving is the classification of measured values or sensor data from the environmental sensors. In particular, it is difficult to distinguish a static obstacle, for example lost cargo on the roadway or the end of a tailback, from horizontal structures that can be driven under, such as, for example, gantries, speed indicators, traffic control systems or the like.

Various methods for confronting this problem are known from the prior art. For example, the sensor data provided by lidar sensors or radar sensors may be projected into a camera image. In this case, the classification of the objects can be carried out in the camera image on the basis of appropriate object recognition algorithms. Furthermore, recognized objects that can be driven under can be plausibilized with moving objects. This is the case, for example, when an object effectively moves through a stationary structure in the sensor data.

DE 10 2017 112 939 A1 describes a radar device for a vehicle, which device comprises probability models in which first and second correlations, which are already known, are modeled for each of the detection ranges, an indicator is determined based on probability ratios relating to a stationary vehicle and an upper object which correspond to the derived parameters and the detection ranges, wherein the first correlations that are already known correlate the parameters and the probabilities relating to the stationary vehicle with one another and the second correlations that are already known correlate the parameters and probabilities relating to the upper object with one another. The radar device performs a threshold determination for the calculated indicators to determine whether the target is the stationary vehicle or the upper object.

Furthermore, DE 10 2015 213 701 A1 discloses a sensor system for a vehicle for recognizing bridges or tunnel entrances. The sensor system comprises a lateral lidar sensor arranged on a first side of the vehicle with a detection region covering a lateral environment of the vehicle. In this case, the lateral lidar sensor is arranged in a manner rotated about a vertical axis, with the result that a front part of the detection region of the lateral lidar sensor in the direction of travel detects an upper spatial region arranged in front of the vehicle at a predetermined range. Furthermore, the lateral lidar sensor is tilted about a transverse axis with respect to the horizontal, with the result that the front part of the detection region of the lateral lidar sensor in the direction of travel detects the distant upper spatial region at a predetermined height above the vehicle.

The object of the present invention is to provide a solution regarding how the classification of objects can be carried out and in particular a distinction can be drawn between objects that can be driven under and relevant objects on the roadway in a simple and nevertheless dependable manner.

This object is achieved by a method, by a computing device, by a driver assistance system and by a computer program having the features of the claimed invention.

A method according to embodiments of the invention is used for classifying objects in an environment of a vehicle. The method comprises receiving sensor data which describe the environment from an environmental sensor of the vehicle. In addition, the method comprises recognizing an object in a region of a roadway on which the vehicle is located on the basis of the sensor data and determining an object region on the roadway, with which object region the object is associated. Furthermore, the method comprises associating a base point with the recognized object on the basis of the sensor data and determining a height of the base point with reference to a vehicle vertical direction of the vehicle. In addition, the method comprises determining a roadway height with reference to the vehicle vertical direction in the object region, wherein the roadway height is determined on the premise of a predetermined grade of the roadway between a forward-zone region of the roadway in front of the vehicle and the object region. Moreover, the method comprises classifying the object as an object that can be driven under if a difference between the roadway height and the height of the base point exceeds a predefined threshold value.

The method is intended to be used to classify objects in the environment of the vehicle. In particular, the intention is to distinguish between objects the vehicle can drive under and relevant objects on the roadway. The objects that can be driven under can be, for example, structures or infrastructure devices that tower above the roadway. Such objects that can be driven under can be, for example, gantries, speed indicators, traffic control systems, bridges or tunnel entrances. The relevant objects on the roadway may be, for example, lost cargo or other road users on the roadway. In particular, static road users or road users with a low speed can be regarded as relevant objects on the roadway. For example, such a relevant object on the roadway can be associated with the end of a tailback. The method is particularly suitable for objects whose distance from the vehicle exceeds a determined minimum distance, for example a distance of 50 m.

The method can be carried out using a corresponding computing device of the vehicle. This computing device can receive the sensor data from the environmental sensor of the vehicle. The environmental sensor may be a distance sensor, for example a lidar sensor or a radar sensor. The environmental sensor can also be in the form of a camera. These sensor data can comprise, for example, a plurality of measured values or measurement points which describe the environment and the objects in the environment. On the basis of these sensor data or the measured values, the computing device is used to recognize the object which is located in the region of the roadway or on the roadway. Furthermore, the object region is associated with this object on the roadway. This object region describes the region of the roadway which is associated with the object or in which the object is located.

In addition, the base point is associated with the object on the basis of the sensor data. In the present case, the base point should not necessarily be understood to mean that point on the object which also touches the surface of the roadway. In the present case, the base point should be understood to mean that point on or measured value relating to the object which is at the shortest distance from the road surface. The base point of the object is therefore in particular that measured value relating to the object which is arranged lowest with reference to the vehicle vertical direction of the vehicle or the vertical. At this base point, a height is determined, this being determined with reference to the vehicle vertical direction of the vehicle.

Furthermore, according to embodiments of the present invention, the roadway height or ground level in the object region is determined. This roadway height is also determined with reference to the vehicle vertical direction or with reference to the installation position of the environmental sensor or a reference point on the vehicle. In this case, the roadway height is determined on the premise of the predetermined grade of the roadway between the forward-zone region in front of the vehicle and the object region. In this case, the forward-zone region describes a region of the roadway which is located in front of the vehicle in the forward direction of travel. From this forward-zone region, the height with reference to the vehicle vertical direction can be determined or is known. In the context of the present invention, the term “grade” should be understood as meaning both an ascent of the roadway and a descent of the roadway. The grade of the roadway is positive on an ascent and negative on a descent. The grade can also be referred to as the gradient. The roadway height in the object region which is associated with the object is determined on the premise that the roadway between the forward-zone region and the object region ascends or just descends.

Furthermore, the object is classified as an object that can be driven under if a difference between the roadway height and the height of the base point exceeds the predefined threshold value. Thus, if the height of the base point of the object is significantly above the supposed roadway height in the object region, it is assumed that this is an object that can be driven under. This takes place on the previously described premise that the height of the roadway in the object region is greater than the height of the roadway in the forward-zone region or in the region of the roadway in which the vehicle is currently located. Thus, the real end of a tailback or a real static obstacle can actually be classified as such in a reliable manner and braking, for example, can be initiated as a result of the correct classification. In this way, the false positive rate for the classification of relevant objects on the roadway and thus a false braking rate can be reduced. Overall, therefore, the classification of the object can be carried out in a simple and nevertheless dependable manner with respect to the false negative rate or unrecognized real objects on the roadway.

Preferably, the object is classified as a relevant object on the roadway if the difference between the roadway height and the height of the base point falls short of the predefined threshold value. If the height of the base point of the object is only a short distance from the supposed roadway height or if the height of the base point falls short of the determined roadway height, it is assumed that the object is a relevant object on the roadway. In particular, it is assumed that it is a static object or obstacle on the roadway. Here, too, the premise that the roadway height in the object region is higher than the roadway height in the forward-zone region of the vehicle can safely ensure that a relevant object on the roadway is not erroneously classified as an object that can be driven under. In the worst case, this could result in the vehicle colliding with the relevant object.

In one embodiment, the grade is predetermined on the premise of a predetermined maximum grade and/or a predetermined maximum change in curvature for the roadway. For example, it may be supposed that the height of the roadway between the forward-zone region and the object region ascends, or descends, linearly. Here, for example, a maximum grade for the roadway may be supposed. This maximum grade can be, for example, between +1% and +10%. This maximum grade can be determined according to the geographical location of the roadway or the geographical circumstances in the environment. For example, the grade may be chosen to be greater in a region with mountains than in the lowlands.

However, there can also be provision for the grade between the forward-zone region and the object region to be predetermined on the basis of a predetermined maximum change in curvature. This means, for example, that the course of the roadway in the vehicle vertical direction, starting from the forward-zone region, is not extrapolated linearly, but with a worst-case curvature supposition. It is thus possible to safely prevent an object that can be driven under from being incorrectly classified as a relevant object on the roadway.

According to a further embodiment, the grade is predetermined on the basis of digital map data, the digital map data describing the grade of the roadway between the forward-zone region and the object region. These digital map data can be used in addition or as an alternative to the supposition of the predetermined maximum grade and/or the predetermined maximum change in curvature. For example, it is merely possible for the information describing the grade or curvature of the roadway to be inferred from highly accurate three-dimensional map data or map sets. There is thus in particular no provision for analyzing the highly accurate three-dimensional map data or geometries of the individual lanes. In this way, the amount of data required for determining the roadway grade or the roadway height can be reduced. The classification can be further improved by taking into account the map data which describe the grade of the roadway.

In principle, it may be supposed that the roadway between the forward-zone region and the object region ascends. If the map data are used for extrapolating the grade and they illustrate that the roadway between the forward-zone region and the object region descends, it may be supposed that the roadway descends at least in some regions. A linear grade, for example a grade between -1% and -10%, or a predetermined change in curvature may be supposed for the descent of the roadway. Furthermore, it is advantageous if the threshold value is determined on the basis of a predetermined maximum height of a lower edge of objects which can be detected on the basis of the sensor data. As already explained, the base point associated with the object cannot describe the region of the object which is also in contact with the roadway or touches the roadway. If the object is, for example, a passenger car or a truck, the wheels or tires of these vehicles cannot be detected on the basis of the measurements with lidar sensors and/or radar sensors. In the case of a truck, for example, the lower loading sill can be recognized on the basis of the sensor data or measured values and can thus be regarded as the base point of the object. The threshold value is thus determined in such a way that it is greater than a height of such a lower edge. In this case, a maximum height of a detectable lower edge of typical road users or objects can be used as a basis. In this case, the threshold value can correspond to this maximum height or can be chosen to be greater than this predetermined maximum height. In this way, an incorrect classification can be reliably prevented.

In addition, there is in particular provision for uncertainties in the sensor data and/or tolerances when determining the roadway height to also be taken into account when determining the threshold value. When the base point of the object is detected, uncertainties or tolerances can be present in the sensor data or measured values. Furthermore, tolerances can be present when determining the roadway height on the basis of the predetermined grade. These uncertainties or tolerances can be taken into account when determining the threshold value. There can be provision, for example, for the threshold value to be determined on the basis of the previously described maximum height of a lower edge of objects and a height value which compensates for the uncertainties and tolerances.

In a further embodiment, the roadway height is determined by determining a height of a road surface of the roadway with reference to the vehicle vertical direction in the forward-zone region on the basis of the sensor data. In other words, the height of the roadway or of the road surface in the forward-zone region can be determined on the basis of the sensor data. In the determined forward-zone region in front of the vehicle, the geometric shape of the ground surface or of the road surface and in particular ascents and drops can be reliably detected using a lidar sensor or radar sensor.

For example, the roadway height in a forward-zone region, which can be at a distance of up to 50 m from the front of the vehicle, can be determined using a lidar sensor or radar sensor.

The method according to embodiments of the invention can be used in particular for objects which are at a predetermined minimum distance from the vehicle or the environmental sensor. The minimum distance can, for example, be greater than 50 m. In particular, the method can be used for objects outside the forward-zone region. The minimum distance depends on the configuration of the environmental sensor, the sensor principle, the installation height of the environmental sensor and/or the environmental conditions.

A computing device according to embodiments of the invention for a driver assistance system is configured to perform a method according to embodiments of the invention. The computing device can comprise, for example, one or more control units.

A driver assistance system according to embodiments of the invention for a vehicle is configured to maneuver the vehicle in an at least semi-automated manner according to a classification of an object in the environment. The driver assistance system comprises the computing device according to embodiments of the invention. Furthermore, the driver assistance system can have at least one environmental sensor. This environmental sensor can preferably be in the form of a lidar sensor or in the form of a radar sensor. There can also be provision for the environmental sensor to be in the form of a camera. By way of the classification of the object as an object that can be driven under or as a relevant object on the roadway, appropriate control signals for the semi-automated maneuvering of the vehicle can be output by way of the computing device. For example, braking can be carried out if the object is classified as a relevant object on the roadway.

A vehicle according to embodiments of the invention comprises a driver assistance system according to embodiments of the invention. The vehicle is in particular in the form of a passenger car.

A further aspect of the invention relates to a computer program comprising commands which, when the program is executed by a computing device, cause the latter to carry out a method according to embodiments of the invention. In addition, the invention relates to a computer-readable (storage) medium, comprising commands which, when executed by a computing device, cause the latter to carry out a method according to embodiments of the invention.

The preferred embodiments presented with reference to the method according to the invention and their advantages apply accordingly to the computing device according to embodiments of the invention, to the driver assistance system according to embodiments of the invention, to the vehicle according to embodiments of the invention, to the computer program according to embodiments of the invention and to the computer-readable (storage) medium according to embodiments of the invention.

Further features of the invention result from the claims, the figures and the description of the figures. The features and combinations of features mentioned above in the description and the features and combinations of features mentioned below in the description of the figures and/or shown in the figures alone may be used not only in the combination indicated in each case but also in other combinations or on their own, without going beyond the scope of the invention.

The invention will now be explained in more detail on the basis of preferred exemplary embodiments and with reference to the accompanying drawings.

### BRIEF DESCRIPTION OF THE DRAWINGS

FIG. 1 shows a schematic representation of a vehicle which comprises a driver assistance system for classifying an object as an object that can be driven under or as a relevant object on the roadway.

FIG. 2 shows a schematic representation of the vehicle on a roadway, of measured values which describe an object, and of a supposition for a course of the roadway.

### DETAILED DESCRIPTION OF THE DRAWINGS

In the figures, identical or functionally identical elements are provided with the same reference numerals.

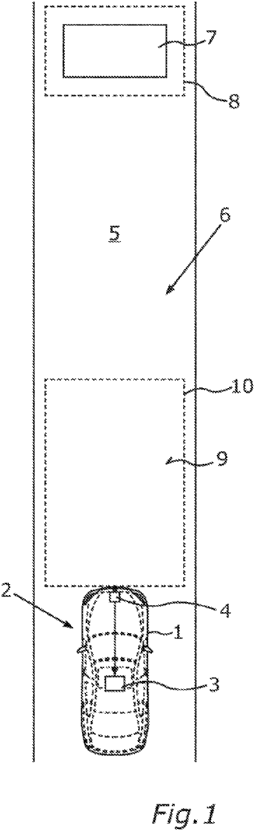

FIG. 1 shows a schematic representation of a plan view of a vehicle 1, which in the present case is in the form of a passenger car. The vehicle 1 comprises a driver assistance system 2, by way of which the vehicle 1 can be maneuvered in an at least semi-automated manner. The driver assistance system 2 comprises a computing device 3, which can be formed, for example, by at least one control unit of the vehicle 1. In addition, the driver assistance system 2 comprises an environmental sensor 4, which can be, for example, in the form of a radar sensor or in the form of a lidar sensor. The environmental sensor 4 can be used to provide sensor data which describe an environment 5 of the vehicle. These sensor data can be transmitted from the environmental sensor 4 to the computing device 3.

In the present case, the vehicle 1 is located on a roadway 6. The sensor data provided using the environmental sensor 4 can be used to recognize an object 7, which in the present case is located on the roadway 6 in front of the vehicle 1 in the direction of travel. The sensor data can be used, for example, to determine the distance between the vehicle 1 and the object 7 and also the relative positions of the vehicle 1 and the object 7.

Furthermore, the sensor data are used to define an object region 8 associated with the object 7 on the roadway 6. Furthermore, the sensor data can be used to detect the roadway 6 or a road surface 9 of the roadway 6 in a forward-zone region 10 in front of the vehicle 1 in the direction of travel. On the basis of the sensor data from the environmental sensor 4, it is possible to detect in particular an ascent or a descent of the roadway 6 in the forward-zone region 10.

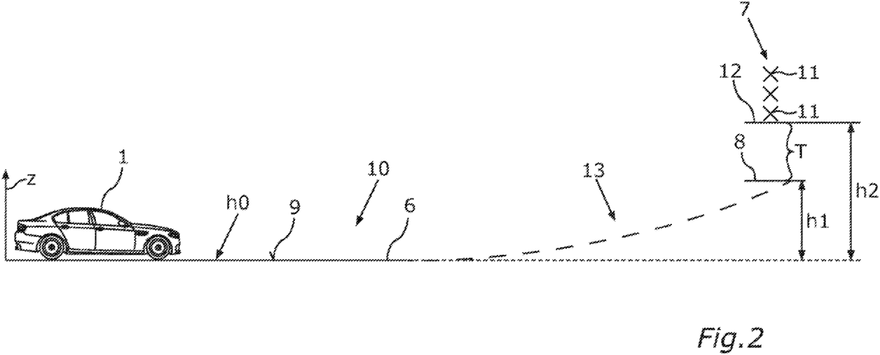

FIG. 2 shows a further representation of the vehicle 1 and of measured values 11 which describe the object 7. In this case, the sensor data provided using the environmental sensor 4 comprise these measured values 11. Only three measured values 11 are depicted in the present case, for the sake of clarity. The present drawing does not show the distance between the vehicle 1 and the object 7 to scale. For example, the distance between the vehicle 1 and the object 7 may be 150 m. In At such distances, in the case of measurements from environmental sensors 4, for example lidar sensors or radar sensors, it is difficult to distinguish a static object, such as lost cargo on the roadway 6 or the stationary end of a tailback, from horizontal structures that can be driven under, for example gantries or speed indicators.

On the basis of the measured values 11, a base point 12 of the object 7 is determined. In this case, the base point 12 describes the point on or measured value 11 relating to the object 7 which is at the shortest distance from the road surface 9 with reference to a vehicle vertical direction z of the vehicle 1. In other words, the base point 12 describes the lowest point on the object 7. As already explained, the grade of the roadway 6 or road surface 9 in the forward-zone region 10 can be detected on the basis of the sensor data. Apropos this, there is provision in the present case for a grade of the roadway 6 to be extrapolated in a region 13. This region 13 of the roadway 6 extends between the forward-zone region 10 and the object region 8 which has been associated with the object 7. In this case, the grade is calculated on the basis of a worst supposition for the grade or change in curvature for the roadway 6. For example, a grade or a change in curvature of 2% may be supposed. This can result, for example, in a height difference of 2 m over a distance of 100 m. In the example, this results in a roadway height h1 in the object region 8 which is 2 m above the measured ground level or a height h0 of the roadway 6 in the forward-zone region 10.

A check is then performed to ascertain whether a difference between a height h2 of the base point 12 and the roadway height h1 is greater than a predefined threshold value T. If this is the case, the object 7 is classified as an object that can be driven under. Otherwise, the object 7 is classified as a relevant object on the roadway 6. This threshold value T can be determined according to a predetermined maximum height of a lower edge of objects which is able to be detected on the basis of the sensor data. This height of the lower edge can correspond, for example, to a typical height of a loading sill of a truck. In addition, uncertainties in the sensor values and/or tolerances when determining the roadway height h1 can be included when determining the threshold value. Overall, therefore, the classification of objects 7 in the environment 5 of the vehicle 1 or on the roadway 6 can be carried out in a simple and nevertheless reliable manner.

1-10. (canceled)

11. A method for classifying objects in an environment of a vehicle, the method comprising:
receiving sensor data which describe the environment from an environmental sensor of the vehicle,
recognizing an object in a region of a roadway on which the vehicle is located based on the sensor data,
determining an object region on the roadway, with which object region the object is associated,
associating a base point with the object based on the sensor data,
determining a height of the base point with reference to a vehicle vertical direction of the vehicle,
determining a roadway height with reference to the vehicle vertical direction in the object region, wherein the roadway height is determined on a premise of a predetermined grade of the roadway between a forward-zone region of the roadway in front of the vehicle and the object region, and
classifying the object as an object that can be driven under upon determining that a difference between the roadway height and the height of the base point exceeds a predefined threshold value.

12. The method according to claim 11, wherein the object is classified as a relevant object on the roadway upon determining that the difference between the roadway height and the height of the base point falls short of the predefined threshold value.

13. The method according to claim 11, wherein the grade is predetermined on the premise of at least one of a predetermined maximum grade or a predetermined maximum change in curvature for the roadway.

14. The method according to claim 11, wherein the grade is predetermined based on digital map data describing the grade of the roadway between the forward-zone region and the object region.

15. The method according to claim 11, wherein the threshold value is determined based on a predetermined maximum height of a lower edge of objects which is able to be detected based on the sensor data.

16. The method according to claim 11, wherein at least one of uncertainties in the sensor data or tolerances when determining the roadway height are also taken into account when determining the threshold value.

17. The method according to claim 11, wherein the roadway height is determined by determining a height of a road surface of the roadway with reference to the vehicle vertical direction in the forward-zone region based on the sensor data.

18. A computing device for a driver assistance system of a vehicle, wherein the computing device is configured to perform the method according to claim 11.

19. A driver assistance system for a vehicle, the driver assistance system comprising:
the computing device according to claim 18, wherein the driver assistance system is configured to maneuver the vehicle in an at least semi-automated manner according to a classification of the object in the environment of the vehicle.

20. A computer product comprising a non-transitory computer readable medium having stored thereon program code which, when executed by a computing device, carries out the method according to claim 11.
